(19) United States
(12) Patent Application Publication
(10) Pub. No.: US 2025/0194760 A1
(43) Pub. Date: Jun. 19, 2025

(54) METHOD FOR MANUFACTURING AN EXTERNAL PART

(71) Applicant: The Swatch Group Research and Development Ltd., Marin (CH)

(72) Inventors: Marek DOVCIK, Mougins (FR); Nicolas FRANÇOIS, Neuchâtel (CH); Sophie NAPOLI, Neuchâtel (CH)

(73) Assignee: The Swatch Group Research and Development Ltd., Marin (CH)

(21) Appl. No.: 18/924,387

(22) Filed: Oct. 23, 2024

(30) Foreign Application Priority Data
Dec. 18, 2023 (EP) 23217717.0

(51) Int. Cl. A44C 27/00; G04B 47/04

(52) U.S. Cl. CPC A44C 27/007; G04B 47/042

(57) ABSTRACT

A method for manufacturing an external part (10) including the steps of: producing a substrate (11) having a cavity (110); producing, by moulding, a decorative element (12) made of a transparent polymer material having a reflective particle filler, wherein the decorative element (12) is formed so as to have at least one decorative head (120) connected to an anchoring foot (121); and fastening the decorative element (12) in the cavity (110) so that the anchoring foot (121) cooperates with the cavity in a form-fitting manner.

### CROSS-REFERENCE TO RELATED APPLICATIONS

This application claims priority to European Patent Application No. 23217717.0 filed Dec. 18, 2023, the entire contents of which are incorporated herein by reference.

### TECHNICAL FIELD OF THE INVENTION

The invention relates to the decoration of timepieces, jewellery or fashion items, and in particular to the manufacture of an external part comprising one or more decorative elements resembling a precious stone.

In this text, the term “precious stone” refers without distinction to precious and semi-precious stones.

This method can be advantageously applied to any external part in the field of watchmaking, jewellery, or fashion items such as leather goods, eyewear, writing instruments or portable electronic devices.

### Technological Background

In order to confer an object high added value, it is often decorated with one or more precious stones driven into a setting. This significantly increases the perceived value of the object.

For both economic and ecological reasons, precious stones can be produced synthetically, in a laboratory. In particular, producing precious stones in a laboratory is considerably less energy-intensive than extracting natural precious stones by mining, and the price of a synthetic stone is between 30 and 40% lower than that of an equivalent natural stone.

A further advantage of synthetically produced stones is that their atomic structure is identical to that of natural mined stones, and they thus have the same visual appearance as natural mined stones.

In order to further reduce the cost of producing this type of decoration, decorative elements that imitate the appearance of precious stones have been developed using a polymer material. However, although the manufacture of these decorative elements requires only a fraction of the energy needed to produce synthetically made stones, their visual appearance is not suitable as a replacement of these stones.

There is thus a need for a decorative element whose production is both inexpensive and consumes little energy, while retaining the decorative elements appreciated in precious stones, such as brilliance or sparkle, thus giving the decorated object a sought-after appearance similar to that described above.

### SUMMARY OF THE INVENTION

To this end, the present invention relates to a method for manufacturing an external part comprising the steps of:
producing a substrate comprising a cavity,
producing, by moulding, a decorative element made of a transparent polymer material having a reflective particle filler, wherein the decorative element is formed so as to have at least one decorative head connected to an anchoring foot,
fastening the decorative element in the cavity so that the anchoring foot cooperates with the cavity in a form-fitting manner.

In particular implementations, the invention can further include one or more of the following features, which must be considered singly or according to any combinations technically possible.

In particular implementations, the decorative element is produced by injection moulding, with the anchoring foot being formed by an injection sprue.

In particular implementations, in the decorative element production step, the decorative element is produced in such a way that the anchoring foot forms a support structure connecting a plurality of decorative heads together.

In particular implementations, an opaque layer is deposited on the anchoring foot by a vacuum thin-film deposition method, by spraying or selective dip-coating, or by injection moulding during the decorative element production step.

In particular implementations, in the decorative element production step, the decorative element is produced in such a way that the decorative element comprises a decorative head connected to an anchoring foot specific thereto.

In particular implementations, in the decorative element fastening step, the anchoring foot is bonded in the portion of the cavity with a complementary shape.

In particular implementations, in the decorative element fastening step, the anchoring foot extends beyond the substrate by an end portion, said end portion being deformed under heat, i.e. after being heated until it softens sufficiently to deform it, in order to generate a permanent bond between the decorative element and the substrate.

In particular implementations, in the decorative element production step, the polymer material is a thermoplastic chosen from a polycarbonate, a polyamide or a poly(methyl methacrylate).

In particular implementations, in the decorative element production step, the polymer material is chosen so as to have an optical transmission coefficient of greater than 80%, or 90%, or even 95%.

In particular implementations, in the decorative element production step, the reflective particles consist of flakes of metallic material and/or of mother-of-pearl, or glass particles with a reflective coating.

In particular implementations, in the decorative element production step, the proportion by mass of the reflective particle filler is less than 1%.

In particular implementations, in the decorative element production step, a thin reflective layer is deposited on at least one face of the decorative element intended to rest facing the cavity in the substrate.

In particular implementations, in the substrate production step, a reflective layer is deposited in the cavity.

In particular implementations, the thin reflective layer is deposited by a vacuum deposition method and is made of SiO2 or TiO2.

In particular implementations, when the decorative element is moulded, the walls of the mould intended to form the decorative head have a mirror-polished surface finish.

In particular implementations, the method comprises a step of polishing the decorative head so that its faces have a mirror-polished surface finish.

In particular implementations, in the decorative element production step, a photoluminescent particle filler is incorporated into the polymer material in proportions by mass of less than 1%.

In particular implementations, in the decorative element production step, once the decorative element has been obtained by moulding, a thin layer of photoluminescent material is deposited on the faces of the head intended to rest facing the cavity in the substrate.

The present invention further relates to an external part produced by a method as described above.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a decorative element production step of the method according to a first example embodiment of the present invention;

FIG. 2 shows the decorative element obtained after carrying out the step in FIG. 1;

FIG. 3 shows a step of fastening the decorative element to a substrate;

FIG. 4 shows a decorative element production step of the method according to an alternative of the first example embodiment of the present invention;

FIG. 5 shows a decorative element production step of the method according to a second example embodiment of the present invention;

FIGS. 6 and 7 show a step of fastening the decorative element to a substrate in a particular form of the second example embodiment of the present invention;

FIGS. 8 to 10 show a step of fastening the decorative element to a substrate in another particular form of the second example embodiment of the present invention.

It should be noted that the figures are not necessarily drawn to scale for reasons of clarity.

### DETAILED DESCRIPTION OF THE INVENTION

The invention relates to a method for manufacturing an external part 10, such as a dial, a flange, a crown or a bezel of a watch, which method comprises steps of producing a substrate 11 and a decorative element 12, followed by a step of fastening the decorative element 12 to the substrate 11 in order to form the external part 10. These steps are described in detail below.

During implementation of the method according to the invention, the substrate 11 is produced in such a way as to comprise a cavity 110 intended to receive a decorative element 12. The substrate 11 can be made of any suitable material, such as a metal, ceramic or polymer material. It should be noted that, although the substrate 11 can have multiple cavities 110, for reasons of clarity it is described with a single cavity 110 in the present text and in the figures.

In particular, the cavity 110 can have a constant cross-section, as shown in FIG. 3, or can have a proximal portion 111 opening onto an external face 112 of the substrate 11 intended to be visible to a user and extended by a distal portion 113 of reduced cross-section, as shown in FIGS. 6 to 10.

The cavity 110 can be a blind or through cavity. In particular, in FIGS. 3, 6 and 7, the cavity 110 is shown to be a blind cavity and in FIGS. 8 to 10, the cavity 110 is shown to be a through-cavity opening, via its distal portion 113, onto an inner face 114 of the substrate 11 opposite the external face 112.

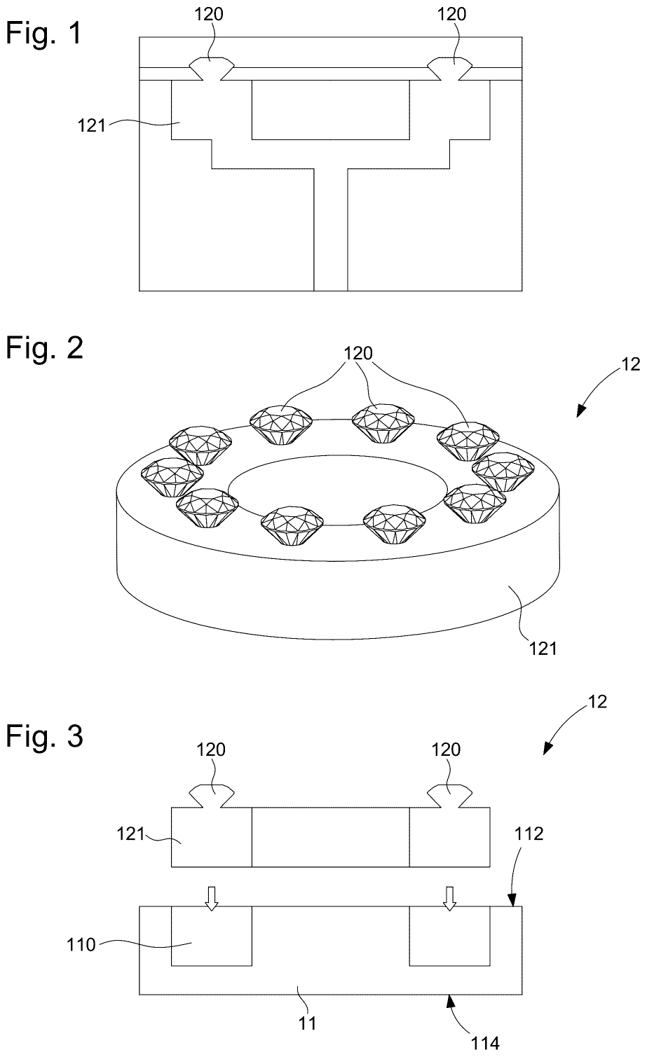

The decorative element 12 is produced by moulding as shown diagrammatically in FIGS. 1 and 5, in a single piece, without any particular chronology with the step of producing the substrate 11. It is made from a transparent polymer material, for example a thermoplastic chosen from polycarbonate, polyamide or poly(methyl methacrylate).

The decorative element 12 is advantageously intended to have a reflective particle filler. These reflective particles help to increase the refractive index of the decorative element 12 and to increase its reflection so as to bring its appearance closer to that of a precious stone. The reflective particles can consist of flakes of a metallic material and/or of mother-of-pearl, and their proportion by mass is typically less than 1%. Moreover, the polymer material is chosen so as to have an optical transmission coefficient greater than 80%, or 90%, or even 95%, so that the visual appearance of the decorative element 12 tends to resemble as much as possible that of a precious stone.

The decorative element 12 is formed so as to have at least one decorative head 120 connected to an anchoring foot 121, as shown in the figures. Preferably, the decorative element 12 is produced by injection moulding, and the anchoring foot 121 is formed by all or part of an injection sprue, as shown in FIGS. 1 and 5. The anchoring foot 121 is thus cylindrical in shape, with a cross-section that can be circular, elliptical or polygonal, etc.

In a first example embodiment shown in FIGS. 1 to 3, the decorative element 12 is produced such that the anchoring foot 121 forms a support structure connecting a plurality of decorative heads 120 together. As can be seen in FIG. 2 in particular, the anchoring foot 121 can, in this case, have an annular shape, the decorative heads 120 being evenly distributed on the foot about an axis of revolution.

In this example embodiment, the method can include a step of depositing an opaque layer on the anchoring foot 121 in order to visually isolate the decorative heads which are transparent. Preferably, the opaque layer is configured so that it has the same visual appearance as that of the external face 112.

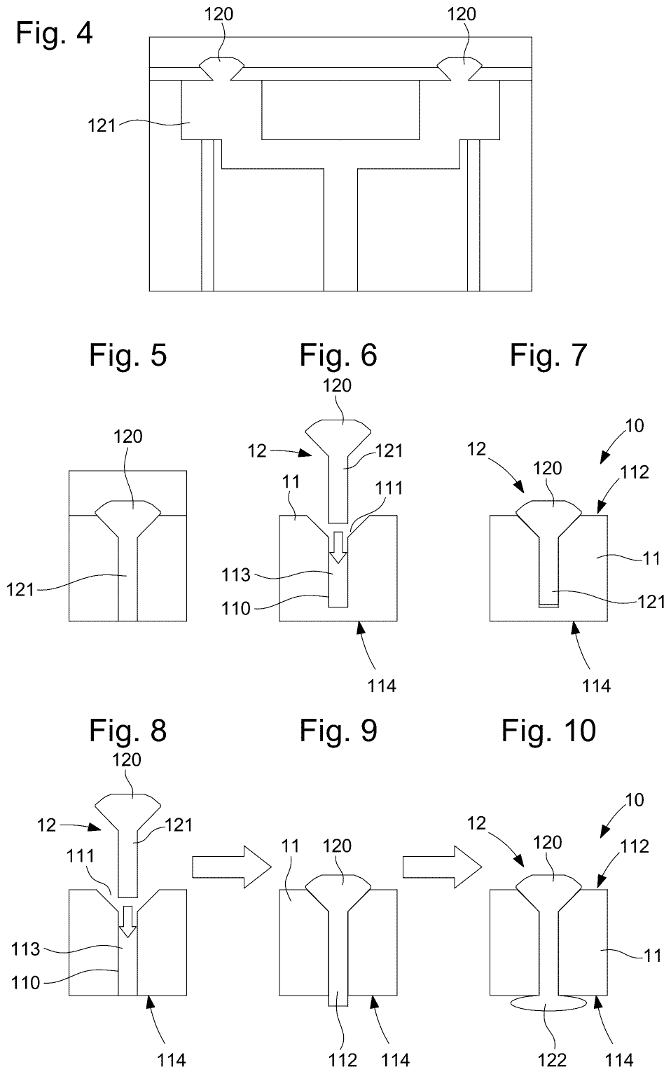

This opaque layer can be deposited on the anchoring foot by a vacuum thin-film deposition method, by spraying or selective dip-coating, or can be deposited by injection moulding during the step of producing the decorative element 12. In particular, as shown in FIG. 4, the opaque layer can be bi-injection moulded with the decorative heads 120 and the anchoring foot 121. The opaque layer can be made of the same polymer material, but has an opaque filler, for example of a given colour.

In a second example embodiment shown in FIGS. 5 to 10, the decorative element 12 is produced such that it comprises a single decorative head 120 connected to an anchoring foot 121 specific thereto.

Preferably, in the step of producing the decorative element 12, a thin reflective layer is deposited on at least one face of the decorative element 12 intended to rest facing the cavity 110 in the substrate 11. Alternatively, in the step of producing the substrate 11, a reflective layer is deposited in the cavity 110. The thin reflective layer can be deposited, for example, by a vacuum deposition method, and is made, for example, of SiO2 or TiO2.

Advantageously, the walls of the mould intended to form the decorative head 120 have a mirror-polished surface finish, so that the faces of the decorative head 120 also have a mirror-polished surface finish. Alternatively, the method can comprise a step of polishing the decorative head 120 so that its faces have a mirror-polished surface finish. This feature increases the transparency of the decorative head 120.

Another feature of the invention making it possible to increase the attractiveness of the visual appearance of the decorative element 12 consists, during the step of producing the decorative element 12, of incorporating into the polymer material a photoluminescent particle filler in proportions by mass of less than 1%. Alternatively or additionally, a thin layer of photoluminescent material can be deposited on the faces of the head intended to rest facing the cavity 110 in the substrate 11.

Once the substrate 11 and the decorative element 12 have been produced, the decorative element 12 is fastened in the cavity 110 in the substrate 11. In particular, during this step, the anchoring foot 121 cooperates with a portion of the cavity 110 of complementary shape.

More specifically, during the fastening step, the anchoring foot 121 is engaged in the cavity 110 until the decorative element 12 comes to a rest, for example via its decorative head 120. The decorative element 12 can be fastened in the cavity 110 by bonding the foot inside the cavity 110, for example when the cavity is blind, as shown in FIG. 7.

Alternatively, if the cavity 110 is a through-cavity, the anchoring foot 121 can extend beyond the substrate 11 via an end portion 122 as shown in FIG. 9. This end portion 122 is deformed under heat, for example by crushing, i.e. after being heated to soften the material, in order to generate a radial lip of material forming an axial stop, as shown in FIG. 10. This axial stop holds the decorative element 12 in position in the cavity 110. It goes without saying that when the end portion 122 of the decorative element 12 is deformed, the latter is subjected to a force opposing that required to crush the material of the end portion 122.

More generally, it should be noted that the implementations and embodiments considered above have been described by way of non-limiting examples, and that other alternatives are thus possible.

For example, in the figures, the decorative heads 120 are shown with facets, a table, a crown and a pavilion in a similar way to a cut precious stone, but they could have a different appearance.

1. A method for manufacturing an external part (10) comprising the steps of:
producing a substrate (11) comprising a cavity (110),
producing, by moulding, a decorative element (12) made of a transparent polymer material having a reflective particle filler, wherein the decorative element (12) is formed so as to have at least one decorative head (120) connected to an anchoring foot (121), and
fastening the decorative element (12) in the cavity (110) so that the anchoring foot (121) cooperates with the cavity in a form-fitting manner.

2. The method according to claim 1, wherein the decorative element (12) is produced by injection moulding, with the anchoring foot (121) being formed by an injection sprue.

3. The method according to claim 1, wherein, in the decorative element (12) production step, the decorative element is produced in such a way that the anchoring foot (121) forms a support structure connecting a plurality of decorative heads (120) together.

4. The method according to claim 3, wherein an opaque layer is deposited on the anchoring foot (121) by a vacuum thin-film deposition method, by spraying or selective dip-coating, or by injection moulding during the decorative element (12) production step.

5. The method according to claim 1, wherein, in the decorative element (12) production step, the decorative element is produced in such a way that the decorative element (12) comprises a decorative head (120) connected to an anchoring foot (121) specific thereto.

6. The method according to claim 5, wherein in the decorative element (12) fastening step, the anchoring foot (121) is bonded in the portion of the cavity (110) with a complementary shape.

7. The method according to claim 5, wherein in the decorative element (12) fastening step, the anchoring foot (121) extends beyond the substrate (11) by an end portion (122), said end portion (122) being deformed under heat in order to generate a permanent bond between the decorative element (12) and the substrate (11).

8. The method according to claim 1, wherein, in the decorative element (12) production step, the polymer material is a thermoplastic chosen from a polycarbonate, a polyamide or a poly(methyl methacrylate).

9. The method according to claim 1, wherein, in the decorative element (12) production step, the polymer material is chosen so as to have an optical transmission coefficient of greater than 80%.

10. The method according to claim 1, wherein, in the decorative element (12) production step, the reflective particles consist of flakes of metallic material and/or of mother-of-pearl.

11. The method according to claim 1, wherein, in the decorative element (12) production step, the proportion by mass of the reflective particle filler is less than 1%.

12. The method according to claim 1, wherein, in the step of producing the decorative element (12), a thin reflective layer is deposited on at least one face of the decorative element (12) intended to rest facing the cavity (110) in the substrate (11).

13. The method according to claim 1, wherein in the step of producing the substrate (11), a reflective layer is deposited in the cavity (110).

14. The method according to claim 12, wherein the thin reflective layer is deposited by a vacuum deposition method and is made of SiO2 or TiO2.

15. The method according to claim 1, wherein, when the decorative element (12) is moulded, the walls of the mould intended to form the decorative head (120) have a mirror-polished surface finish.

16. The method according to claim 1, further comprising a step of polishing the decorative head (120) so that its faces have a mirror-polished surface finish.

17. The method according to claim 1, wherein, in the decorative element (12) production step, a photoluminescent particle filler is incorporated into the polymer material in proportions by mass of less than 1%.

18. The method according to claim 1, wherein, in the decorative element (12) production step, once the decorative element (12) has been obtained by moulding, a thin layer of photoluminescent material is deposited on the faces of the head intended to rest facing the cavity (110) in the substrate (11).

19. An external part (10) produced using the method according to claim 1.
